(19) United States
(12) Patent Application Publication
(10) Pub. No.: US 2004/0240770 A1
(43) Pub. Date: Dec. 2, 2004

(54) Reducing the polarization dependent coupling coefficient in planar waveguide couplers

(76) Inventors: Mahesh R. Junnarkar, San Jose, CA (US); Anirban Bandyopadhyay, San Jose, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/448,832

(22) Filed: May 30, 2003

(51) Int. Cl. G02B 6/12

(52) U.S. Cl. 385/14; 385/42

(57) ABSTRACT

A planar light wave circuit may include a directional coupler with two waveguides come close to one another in a so-called gap region. Polarization dependent coupling may be reduced by forming trenches on either side of the gap region to reduce birefringence.

### BACKGROUND

This invention relates generally to planar light circuits for optical systems.

Optical systems may communicate using light signals. In some cases, light signals of different wavelengths are multiplexed together in what is known as a wavelength division multiplexing system. A planar light wave circuit is an optical device formed using conventional semiconductor fabrication techniques.

A coupler is an optical device that enables light from different sources to be combined. A directional coupler is a coupler that only allows light to pass in one direction. Directional couplers may be used, for example, when optical power is to be split into two routes in a predetermined ratio, when combining optical power from two different channels into a single channel, and for tapping power for power monitoring purposes, as well as routing signals into different channels.

An evanescent coupler is a type of directional coupler with relatively low insertion loss using silica on silicon technology. Unfortunately, the coupling coefficient of evanescent couplers is sensitive to polarization of the incoming light wave. As a result, the output power in either of the output ports of the coupler varies, generating different ratios of power at different output ports as the incoming polarization changes.

Thus, there is a need for a way to reduce the dependence of couplers on polarization of the incident light.

### BRIEF DESCRIPTION OF THE DRAWINGS

FIG. 1 is a top plan view of one embodiment of the present invention; and

FIG. 2 is an enlarged cross-sectional view taken generally along the line 2-2 in FIG. 1 in accordance with one embodiment of the present invention.

### DETAILED DESCRIPTION

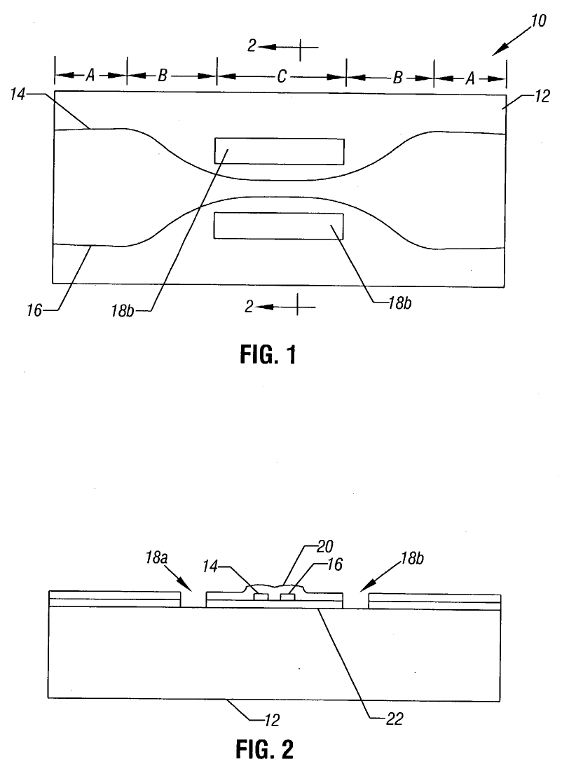

Referring to FIG. 1, a planar light circuit (PLC) 10 may be formed using semiconductor integrated circuit fabrication techniques. A 2×2 coupler 12 is shown for illustration purposes only.

The circuit 10 includes a first waveguide 14 and a second waveguide 16. The waveguides 14, 16 may be hour glass shaped in one embodiment. The waveguides 14 and 16 begin in a region A on an input side and end in the region A on the output side. In the regions A, the waveguides 14 and 16 are widely separated from one another. The waveguides 14, 16 taper towards one another in the region B on the input side and taper away from one another in the region B on the output side. In the region C, the waveguides 14 and 16 are relatively close to one another.

A significant source of polarization dependent coupling in a coupler 12 is due to a mismatch of stress induced birefringence between the cores of the waveguides 14 and 16 and the region between them. With silica on silicon couplers, the thermal coefficient of expansion of the substrate is large compared to the overlying areas of doped and undoped silica. The mismatch in thermal coefficient of expansion gives rise to highly compressive stresses in the upper layers along the plane of the coupler. Such mismatches of thermal coefficients of expansion in multilayer systems result in polarization dependent coupling.

The stress in the uppermost layer in the vertical direction is comparatively less, as the uppermost layer can expand or contract more freely in the vertical direction than in the lateral direction because of the lateral boundary. This arrangement is true to a lesser degree with respect to the core and the lower cladding. This mismatch in stress between the lateral and the vertical directions generates what is known as a birefringence or change of refractive index along X and Y directions.

In evanescent couplers, the problem is more complicated as the two coupled waveguides 14, 16 have to be very close together in the region C in FIG. 1. The high thermal coefficient of expansion in the upper cladding material cannot reduce the stress in the lower cladding material, which may be thermal oxide. The highly stressed lower cladding generates a highly stressed region between two comparatively low stress core waveguides. When the two core waveguides are placed very close to one another in the region C, the stress on the cores in the gap region C may be six to seven times larger than in the rest of the core in one embodiment. The effective refractive index contrast between the core and the gap region becomes different in the X and Y directions, giving rise to a large polarization dependent coupling.

The gap stress may be reduced by introducing trenches 18a and 18b on the two outer sides of the waveguides 14 and 16. The stress in the cores and the gap region can be relaxed in the lateral direction due to the presence of the side trenches. This helps reduce the birefringence in the gap region, and increase the birefringence in the core slightly and thereby reduce the difference in stress levels between the cores and the gap region.

By means of illustration only and without limitation, in a coupler with a 5 micron×6 micron core, trenches 18 having a width of 15 microns, a depth of 30 microns, and a distance from the core of 15 microns, may significantly reduce birefringence in the gap region.

In some embodiments it may also be desirable to boron dope the core material to further reduce birefringence.

Referring to FIG. 2, a semiconductor substrate 12 may be covered by a lower cladding 22. An upper cladding 20 may be positioned over the cores 14 and 16. The trenches 18a and 18b may penetrate through the upper and lower cladding 20 and 22 in one embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming a coupler in a planar light wave circuit having a gap region; and
forming a trench in said circuit on at least one side of said gap region.

2. The method of claim 1 including forming a trench on either side of said gap region.

3. The method of claim 1 including forming a directional coupler.

4. The method of claim 3 including forming an evanescent coupler.

5. The method of claim 1 including forming a pair of waveguides having an hour glass shape, said gap region being the region where said waveguides come closest together.

6. The method of claim 5 including forming said waveguide including a core, an upper cladding, and a lower cladding.

7. The method of claim 6 including forming said trench through said upper and lower cladding.

8. The method of claim 1 including forming a silica on silicon planar light wave circuit.

9. The method of claim 1 including forming said trench so as to reduce polarization dependent coupling.

10. The method of claim 1 including forming a coupler having a pair of waveguides, said waveguides being covered by an upper cladding material and then doping said upper cladding material with boron.

11. A planar light wave circuit comprising:
a coupler having a gap region; and
a trench on at least one side of said coupler proximate to said gap region.

12. The circuit of claim 11 including a trench on either side of said gap region.

13. The circuit of claim 11 wherein said coupler is a directional coupler.

14. The circuit of claim 13 wherein said coupler is an evanescent coupler.

15. The circuit of claim 11 including a pair of waveguides having an hour glass shape to form said coupler, said gap region being the region where said waveguides come closest together.

16. The circuit of claim 15 wherein each of said waveguides includes a core, an upper cladding, and a lower cladding.

17. The circuit of claim 16 wherein said trench extends through said upper and lower cladding.

18. The circuit of claim 11 wherein said circuit is a silica on silicon planar light wave circuit.

19. The circuit of claim 11 wherein said trench is to reduce polarization dependent coupling.

20. The circuit of claim 11 wherein said coupler includes a pair of waveguides, said waveguides being covered by an upper cladding material, said upper cladding material being doped with boron.

21. A planar light wave circuit comprising:
an evanescent directional coupler having an hour glass shape including two more widely spaced regions and a less widely spaced region; and
a trench on both sides of said less widely spaced region.

22. The circuit of claim 20 wherein each of said waveguides includes a core, an upper cladding, and a lower cladding.

23. The circuit of claim 21 wherein said trench extends through said upper and lower cladding.

24. The circuit of claim 21 wherein said circuit is a silica-on-silicon planar light wave circuit.

25. The circuit of claim 21 wherein said trench to reduce polarization dependent coupling.

26. The circuit of claim 21 wherein said coupler includes a pair of waveguides covered by an upper cladding material, said upper cladding material being boron doped.
